(19) United States
(12) Patent Application Publication
(10) Pub. No.: US 2008/0051093 A1
(43) Pub. Date: Feb. 28, 2008

(54) Characterization of Cellular Telecommunications Network Area

(75) Inventors: Kai Ojala, Oulu (FI); Yrjo Porsti, Oulu (FI)

Correspondence Address: OLIFF & BERRIDGE, PLC, P.O. BOX 320850, ALEXANDRIA, VA, 22320-4850, US

(73) Assignee: ANITE FINLAND OY, OULU (FI)

(21) Appl. No.: 11/630,971

(22) PCT Filed: Jun. 30, 2005
(86) PCT No.: PCT/FI05/50259

§ 371 Date: Dec. 28, 2006

(30) Foreign Application Priority Data
Jul. 2, 2004 (FI) 20040928

(51) Int. Cl. H04Q 7/20

(52) U.S. Cl. 455/439

(57) ABSTRACT

A system, a computer program product and a method of characterizing a cellular telecommunications network area are disclosed. The method comprises: receiving (606) measurement data characterizing measured cell quality of a plurality of radio cells in a plurality of spatiotemporal coordinate points; selecting (608) a plurality of sub-areas within a cellular telecommunications network area, each sub-area confining a plurality of spatiotemporal coordinate points; calculating (610) sub-area cell quality parameters of radio cells, each sub-area cell quality parameter representing cell quality of a radio cell within a sub-area and being calculated by combining measurement data within the sub-area; and generating (612) a cell preference list for at least a portion of the cellular telecommunications network area on the basis of the sub-area cell quality parameters.

### FIELD

The invention relates to a method of characterizing a cellular telecommunications network area, a system for characterizing a cellular telecommunications network area, and a computer program product embodied on a computer readable distribution medium, the computer program product encoding a computer program of instructions for executing a computer process for characterizing a cellular telecommunications network area.

### BACKGROUND

While moving from one cell area to another or establishing a connection to the infrastructure of a cellular telecommunications network from scratch, a mobile terminal is required to carry out a cell selection procedure involving monitoring, measurements, and comparison of the quality of candidate radio cells. In order to direct the aforementioned tasks to desired radio cells, prior information, such as a cell preference list and characteristics of associated pilot channels, is required by the mobile terminal. Such information is provided for the mobile terminal by a current serving cell as a form of system information signalled to the mobile terminal.

A cell preference list is typically formed by a network planning engineer during network planning. The cell preference list is based on characterization of the cellular telecommunications network area. The characterization is typically based on, for example, computer simulations emulating a cellular telecommunications network and a radio environment.

The computer simulations, however, fail to account for real characteristics of the cellular telecommunications network and the radio environment. Furthermore, human aspects in the network planning may have an undesired impact on the planning result. Therefore, it is desirable to consider alternative techniques for characterizing a cellular telecommunications network area.

### BRIEF DESCRIPTION OF THE INVENTION

An object of the invention is to provide a method, a system, and a computer program product for characterizing a telecommunications network area. According to a first aspect of the invention, there is provided a method of characterizing a cellular telecommunications network area, the method comprising: receiving measurement data characterizing measured cell quality of a plurality of radio cells in a plurality of spatiotemporal coordinate points; selecting a plurality of sub-areas within a cellular telecommunications network area, each sub-area confining a plurality of spatiotemporal coordinate points; calculating sub-area cell quality parameters of radio cells, each sub-area cell quality parameter representing cell quality of a radio cell within a sub-area and being calculated by combining measurement data within the sub-area; and generating a cell preference list for at least a portion of the cellular telecommunications network area on the basis of the sub-area cell quality parameters.

According to a second aspect of the invention, there is provided a system for characterizing a cellular telecommunications network area, comprising: a receiving means for receiving measurement data characterizing measured cell quality of a plurality of radio cells in a plurality of spatiotemporal coordinate points; a selecting means for selecting a plurality of sub-areas within a cellular telecommunications network area, each sub-area confining a plurality of spatiotemporal coordinate points; a calculating means for calculating sub-area cell quality parameters of radio cells, each sub-area cell quality parameter representing cell quality of a radio cell within a sub-area and being calculated by combining measurement data within the sub-area; and a preference list generating means for generating a cell preference list for at least a portion of the cellular telecommunications network area on the basis of the sub-area cell quality parameters.

According to another aspect of the invention, there is provided a computer program product embodied on a computer readable distribution medium, the computer program product encoding a computer program of instructions for executing a computer process for characterizing a cellular telecommunications network area, the computer process comprising: receiving measurement data characterizing measured cell quality of a plurality of radio cells in a plurality of spatiotemporal coordinate points; selecting a plurality of sub-areas within a cellular telecommunications network area, each sub-area confining a plurality of spatiotemporal coordinate points; calculating sub-area cell quality parameters of radio cells, each sub-area cell quality parameter representing cell quality of a radio cell within a sub-area and being calculated by combining measurement data within the sub-area; and generating a cell preference list for at least a portion of the cellular telecommunications network area on the basis of the sub-area cell quality parameters.

The invention provides several advantages. In an embodiment of the invention, the system, method, and computer program product provide an accurate characterization of the cellular telecommunications system network area, thus enabling reliable cell preference lists to be generated according to which a network planning engineer is capable of configuring the cellular telecommunications network in an optimised manner. A reliability is based on real observations of radio cell quality and the use of a combination of measurement data elements.

### LIST OF DRAWINGS

In the following, the invention will be described in greater detail with reference to the embodiments and the accompanying drawings, where

FIG. 1 shows an example of a cellular telecommunications network;

FIG. 2 shows an example of measurement data distribution in a cellular telecommunications network area;

FIG. 3 shows an example of a structure of a system for characterizing a cellular telecommunications network area;

FIG. 4 shows an example of sub-area distribution in a cellular telecommunications network area;

FIG. 5A shows a first example of formation of a sub-area;

FIG. 5B shows a second example of a formation of a sub-area;

FIG. 6 shows a first example of a methodology according to embodiments of the invention;

FIG. 7 shows a second example of a methodology according to embodiments of the invention; and

FIG. 8 shows yet another example of a methodology according to embodiments of the invention.

### DESCRIPTION OF EMBODIMENTS

The invention may be applied to a cellular telecommunications system comprising one or more radio access technologies, such as GSM (Global System for Mobile Communications), GERAN (GSM/EDGE Radio access network), GPRS (General Packet Radio Service), UMTS (Universal Mobile Telecommunications System), CDMA2000 (CDMA, Code Division Multiple Access), US-TDMA (US Time Division Multiple Access), MC-CDMA (Multi-Carrier Code Division Multiple Access) and/or OFDMA (Orthogonal Frequency Division Multiple Access) technologies, without limiting the invention to these systems. It is presumed that the structure and operation of such radio access technologies and an associated network are known to one skilled in the art.

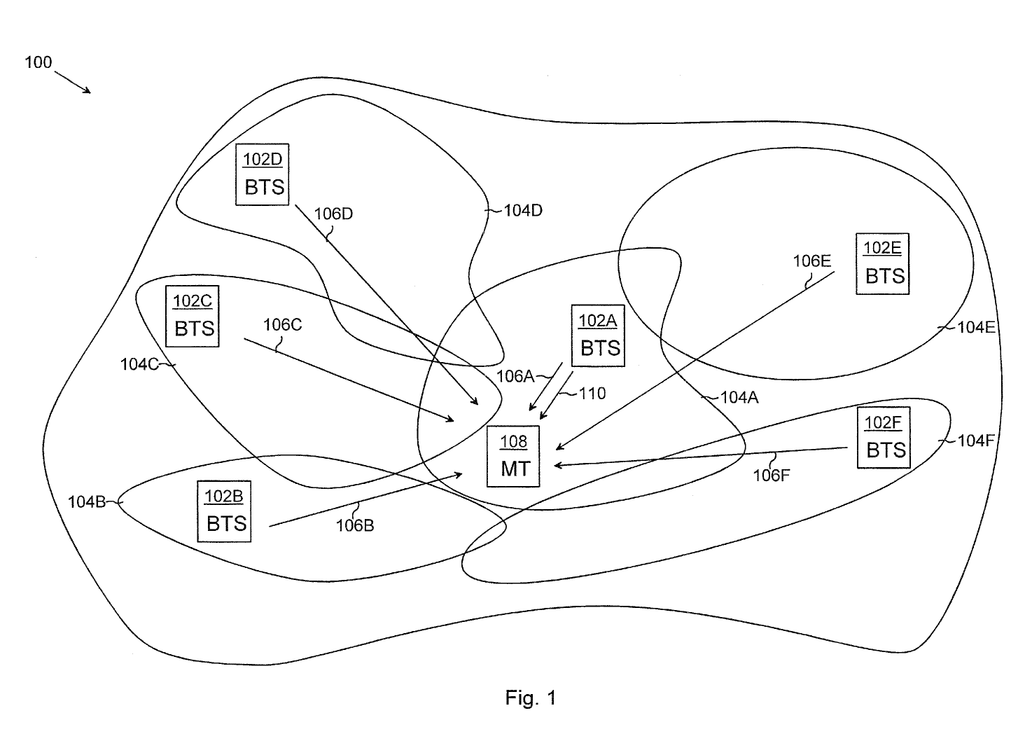

With reference to FIG. 1, examine an example of a sample of a cellular telecommunications network area 100 of a cellular telecommunications system.

A telecommunications network area 100 comprises base stations 102A to 102F providing radio cells 104A to 104F. In some embodiments, a base station 102A to 102F may provide a plurality of radio cells 104A to 104F. A cell-specific frequency band and/or scrambling code may be allocated to a radio cell 104A to 104F.

The sample of a cellular telecommunications network area 100 may represent a complex cell structure where a plurality of radio cells overlap and the operating area of each radio cell 104A to 104B is affected by external factors, such as an urban infrastructure and local geography. Such factors set a great challenge for network planning.

FIG. 1 further shows a mobile terminal 108 being camped on a serving cell 104A. While being camped, the mobile terminal 108 receives a system information signal 110 transmitted in the serving cell 104A by a serving base station 102A.

The system information signal 110 delivers system information to the mobile terminal 108. The system information comprises system parameters, for example, associated with handover procedures where the mobile terminal 108 changes a serving cell from one cell to another. The system information may further include a neighbor cell list defining radio cells to be monitored by the mobile terminal 108 while being camped on the serving cell 104A.

A neighbor list includes typically channel numbers according to which pilot signals 106A to 106F transmitted to the radio cells 104A to 104F may be received.

Monitoring of the radio cells 104A to 104F may be followed by measurements of channel characteristics from the pilot signals 106A to 106F transmitted to the radio cells 104A to 104F. Measurement results may be compared and a new serving cell may be selected on the basis of the comparison.

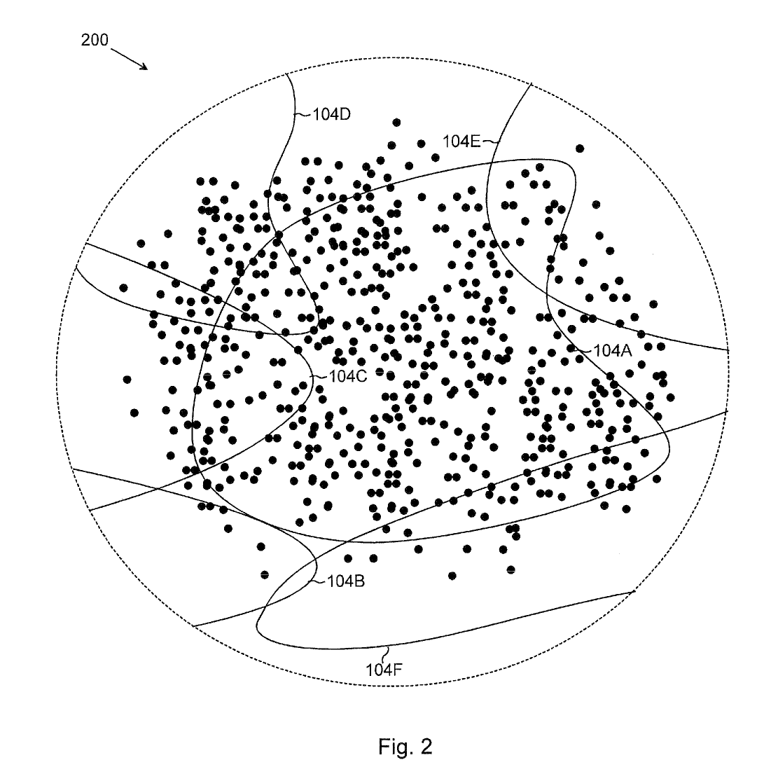

With reference to FIG. 2, a portion 200 of the cellular telecommunications network area 100 of FIG. 1 is shown.

Black dots represent measurement data elements of measurement data collected in the portion 200 of the cellular telecommunications network area. Each measurement data element comprises a cell quality parameter of a radio cell 104A to 104F and a spatiotemporal coordinate point indicating the place and/or time of measurement of each measurement data element.

A cell quality parameter typically characterizes quality of a radio cell 104A to 104F experienced by a receiver. In an embodiment of the invention, the cell quality parameter is a channel quality estimate, such as an E_{c}/No value (ratio of energy per modulating bit to the noise spectral density) and/or an RSCP (Received Signal Code Power), measured from a pilot channel or other signal including a predetermined bit sequence, such as a P-CPICH (Primary Common Pilot Channel), without restricting the cell quality parameters to the given examples.

A spatiotemporal coordinate point may include spatial coordinates, such as those given in a (x, y, z) coordinate system. Furthermore, a spatiotemporal coordinate point may include the measurement time of each measurement data element.

Each measurement data element may be expressed as
D=D_{CI}(S,T), (1)
where D indicates the numerical value of measured cell quality, CI indicates a cell identifier, S indicates spatial coordinates of the measurement, and T indicates time of the measurement. The cell identifier is used as identification information for a radio cell 104A to 104F. The radio cell 104A to 104F may be identified by using pilot channel characteristics and/or separate symbols transmitted in other channels.

The cell identifier may indicate a radio cell characteristic, such as a scrambling code, and/or a radio frequency band applied to the radio cell 104A to 104F. In some embodiments, the cell identifier may include a BSIC (Base Transceiver Station Identity Code).

The measurement data may be collected by a measurement system located in a moving vehicle, for example. In such a case, the measurement data elements typically concentrate in the proximity of traffic passages.

In an embodiment of the invention, the measurement data are provided by scanning pilot channels transmitted to the radio cells 104A to 104F. In a scanning procedure, a receiver may scan a predetermined frequency range and carry out a synchronization procedure to obtain a frequency and/or time synchronization with a received signal. A scanning procedure may further include a scan over a group of scrambling codes in order to identify a cell and/or a base station sector.

For each measurement data element, spatiotemporal coordinate points are registered. In an embodiment of the invention, at least some of the spatiotemporal coordinate points are obtained from a satellite positioning system, such as the GPS (Global Positioning System), the GLONASS (Global Navigation Satellite System), and/or Galileo satellite radio navigation system. Time information on each measurement data element may be obtained from a satellite positioning system and/or from an internal clock of the measurement system.

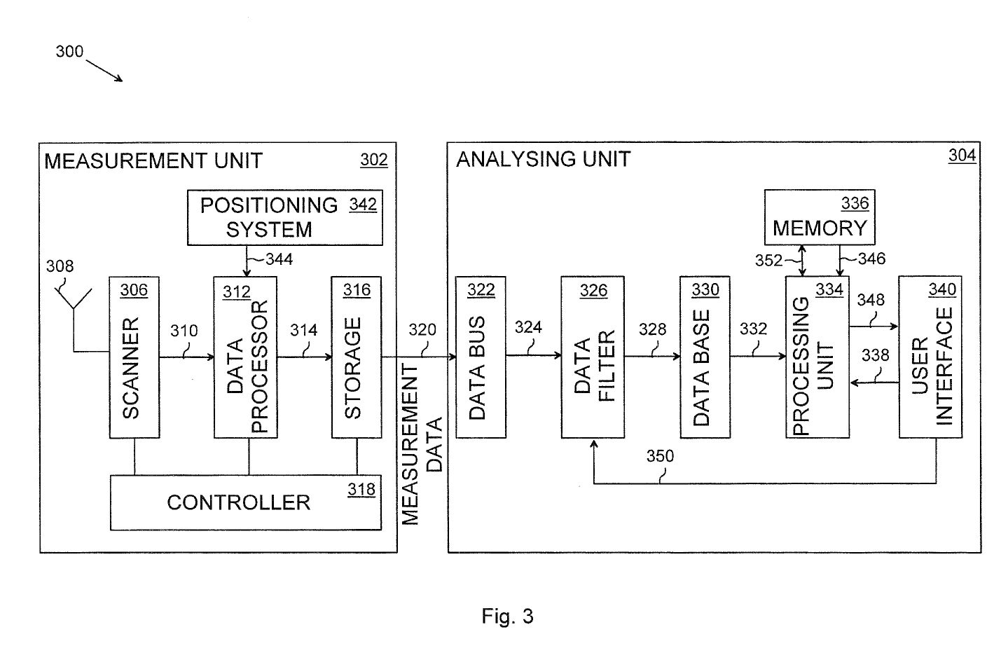

With reference to FIG. 3, a system 300 for characterizing a cellular telecommunications area is illustrated. The system 300 may be divided into a measurement unit 302 and an analysing unit 304.

The measurement unit 302 includes a scanner 306, an antenna 308 connected to the scanner 306, a data processor 312, a data storage 316, a positioning system 342, and a controller 318.

The scanner 306 provides a radio interface with the cellular telecommunications system and is responsible of receiving radio transmission from a radio environment. The scanner 306 scans a given frequency range and/or a scrambling code space, and outputs scanning results 310 into the data processor 312. It should be noted that the scanner 306 typically operates independently from a neighbour list or other network information provided by the telecommunications system, and thereby provides a real insight into the radio traffic occurring in the cellular telecommunications system network area.

The scanning results 310 typically include channel quality estimates, such as Ec/No and/or RSCP values, determined for pilot channels received by the scanner 306. Furthermore, the scanning result may include the carrier frequency and/or scrambling code number associated with each channel quality estimate. The carrier frequency and/or the scrambling code number are used to associate the channel quality estimate with a correct radio cell.

The scanner 306 typically includes a radio receiver and a digital signal processor. A detailed structure of the scanner 306 is known to one skilled in the art, and will not be given in this context.

The positioning system 342 determines the spatial coordinates, such as (x, y, z) coordinates, by using signals received from satellites of a satellite positioning system. In an embodiment of the invention, time information for each channel quality estimate is further provided by the positioning system 342.

The positioning system 342 may be external to other parts of the measurement unit 302. In an embodiment of the invention, the positioning system 342 is integrated into the scanner 306.

The data processor 312 receives the scanning results 310 and spatiotemporal coordinate point information 344 and stamps each cell quality parameter with a spatiotemporal coordinate point registered by the positioning system 342. Furthermore, the data processor 312 may input the measurement data 314 into the data storage 316 in a desired format.

The controller 318 may initiate the operation of scanner 306 and define the scanning parameters, such as those associated with frequency range and scrambling codes, used in a scan. The controller 318 may further define the data format in which the data processor 312 inputs the measurement data 316 into the data storage 316.

The data processor 312, the data storage 316, and the controller 318 may be implemented with a personal computer and software. The scanner 306 may be connected to the personal computer via a PCI (Peripheral Component Interconnect) bus and/or a USB (Universal Serial Bus), for example.

Some parts, such as the scanner 306, the positioning system 342, and the data processor 312, may be located in a moving unit, such as a vehicle. Some parts, such as the data storage 316, may be located in a fixed position, such as the networks operator's facility. The measurement data 314 may be transferred from the moving unit to the fixed position over the cellular telecommunications network.

A data bus 322 receives the measurement data 320. The data bus 320 may provide an interconnection between the analysing unit 304 and the measurement unit 304. In an embodiment of the invention, the data bus 322 is connected to a distribution medium, such as a computer readable memory, a compact disk drive, a computer readable signal and/or other means by which measurement data may be stored in and/or transferred to the analysing unit 304. In such a case, the measurement unit 302 may input the measurement data into the distribution medium.

The analysing unit 304 typically includes a data bus 322, a data filter 326, a database unit 330, a processing unit, a memory unit 336, and a user interface 340. The user interface may include an input device, such as a keyboard, and an output device, such as a graphical display.

The measurement unit 302 typically forms an operating measurement as such for the use of a field measurement team. The analysing unit 304 may form an analysing tool kit as such for the use of a network planning engineer. In such a case, the measurement data may be transferred from the measurement unit 302 to the analysing unit 304 by using the distribution medium. The analysing unit 304 may further be integrated into a larger network planning and configuration system.

In an embodiment of the invention, the measurement unit 302 and the analysing unit 304 form an integrated system sharing processing resources, data storage resources, memory resources and a user interface.

The data bus 322 inputs the measurement data 324 into a data filter 326. The data filter 326 may sort out undesired measurement data elements from the measurement data 324, and it inputs accepted measurement data 328 into the data base unit 330. The data filter 326 may, for example, sort out measurement data elements with spatiotemporal coordinate points that lie outside a given coordinate range in order to limit the number of measurement data elements entering the analysing unit 304. For example, the user may define a coordinate range, such as that illustrated with a dashed line in FIG. 2, to be considered in an analysis by using the user interface 340. The user interface 340 may provide an instruction signal 350 to limit the spatiotemporal coordinate range for the data filter 326. The data filter 326 may be implemented with a digital processor and software, for example.

The processing unit 334 reads measurement data 332 and processes the measurement data 332 according to a computer process encoded in a computer program stored in the memory unit 336.

The user interface 340 provides a user, such as a network planning engineer, with a capability of operating the analysing unit 304 and monitoring processing results 348 generated by the processing unit 334.

The user interface 340 further provides the user with a capability of inputting operating commands 338, such as those associated with selecting the sub-areas 2A to 2E, into the processing unit 334.

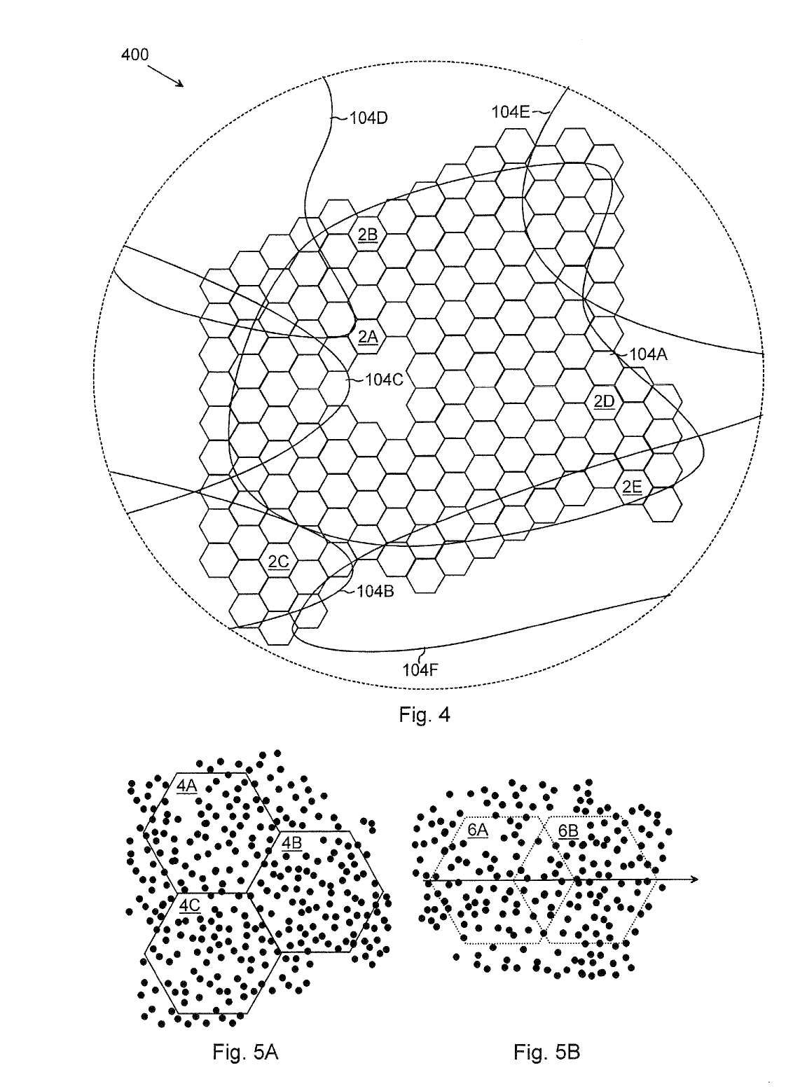

With reference to FIG. 4, consider a cellular telecommunications system area 400 as an example.

The processing unit 334 selects a plurality of sub-areas within the cellular telecommunications network area 400. For the ease of discussion, the sub-areas are illustrated with hexagons and only a group of hexagons 2A to 2E is provided with reference numerals. The sub-areas 2A to 2E are not, however, restricted to a hexagonal shape and/or uniform size, but the shape and size may be selected freely, provided that a sufficient number of measurement data elements is included in each sub-area 2A to 2E.

The spatial dimension of a sub-area may vary from dozens of meters to hundreds of meters, without restricting the spatial dimension to the given figures. The temporal dimension of a sub-area 2A to 2E may vary from seconds to days, without restricting the temporal dimension to the given figures.

Each sub-area 2A to 2E confines spatiotemporal coordinate points. Measurement data elements having spatiotemporal coordinate points confined by a sub-area 2A to 2E are deemed to be included in said sub-area 2A to 2E.

A sub-area 2A to 2E may have a temporal dimension. For example, the time dimension of a sub-area 2A to 2E may range between a first time instant t₁ and a second time instant t₂. That is, measurement data elements recorded between t₁ and t₂ are included in the sub-area 2A to 2E provided that the measurement data elements lie within the spatial coordinate range of the sub-area 2A to 2E.

In an embodiment of the invention, the user interface 340 may provide the user with a capability of selecting graphically sub-areas 2A to 2E by using a map view and a mouse or another pointing device. In an embodiment of the invention, the user interface 340 may provide the user with a capability of selecting the sub-areas 2A to 2E by entering sub-area coordinates with a keyboard. The processing unit 334 may aid to select the sub-areas 2A to 2E by suggesting suitable sub-areas to be selected and by informing the user whether or not a selected sub-area 2A to 2E includes sufficiently measurement data elements for a proper statistical group.

The user may input a selection command specifying a selection of a sub-area 2A to 2E into the user interface 340 which inputs the selection command 350 into the processing unit 334.

The processing unit 334 calculates sub-area cell quality parameters for each sub-area 2A to 2E by combining measurement data within the sub-area 2A to 2E. Each sub-area cell quality parameter represents cell quality of a radio cell 104A to 104F within a sub-area 2A to 2E.

Sub-area cell quality parameters for a sub-area 2A to 2E may be expressed as

$$\begin{matrix}{D}_{104 A}^{SAI} = F ( {D}_{104 A} ( {S}_{1} , {T}_{1} ) , … , {D}_{104 A} ( {S}_{i} , {T}_{j} ) , … , {D}_{104 A} ( {S}_{N} , {T}_{M} ) ) \\ {D}_{104 B}^{SAI} = F ( {D}_{104 B} ( {S}_{{1}^{′}} , {T}_{{1}^{′}} ) , … , {D}_{104 B} ( {S}_{{i}^{′}} , {T}_{{j}^{′}} ) , … , {D}_{104 B} ( {S}_{{N}^{′}} , {T}_{{M}^{′}} ) ) \\ ⋮ \\ {D}_{104 F}^{SAI} = F ( {D}_{104 F} ( {S}_{{1}^{″}} , {T}_{{1}^{″}} ) , … , {D}_{104 F} ( {S}_{{i}^{″}} , {T}_{{j}^{″}} ) , … , {D}_{104 F} ( {S}_{{N}^{″}} , {T}_{{M}^{″}} ) ) ,\end{matrix}$$

where D_{104A}^{SAI}, D_{104B}^{SAI}, . . . , D_{104F}^{SAI} are the cell quality parameters, such as E_{c}/No and/or RSCP values, calculated for radio cells 104A, 104B, . . . , 104F, respectively. The superscript SAI indicates a sub-area identifier identifying a single sub-area 2A to 2E.

Each sub-area cell quality parameter D_{104A}^{SAI}, D_{104B}^{SAI}, . . . , D_{104F}^{SAI} has a function dependence F on measurement data element D_{CI}(Sᵢ,Tⱼ) where the superscript of D indicates a radio cell 104A to 104F and subscripts i and j are used as indices for spatiotemporal coordinate points confined by a sub-area SAI. Integers N and M indicate the number of spatial coordinate points and time instants, respectively.

Each sub-area cell quality parameter D_{CI}^{SAI} characterizes quality of a radio cell identified with a cell identifier CI in sub-area SAI. The measurement data elements may be combined D_{CI}(Sᵢ,Tⱼ) in various ways to provide a sub-area cell quality parameter D_{CI}^{SAI}.

In an embodiment of the invention, a statistical average is used for calculating the cell quality parameter D_{CI}^{SAI}. In such a case, a cell quality parameter D_{CI}^{SAI} may be written as

$${D}_{CI}^{SAI} = \frac{\sum {w}_{i , j} {D}_{C I} ( {S}_{i} , {T}_{j} )}{\sum {w}_{i , j}} , \qquad ( 2 )$$

where summation runs over N and M and wᵢⱼ is the weight factor of each measurement data element.

With reference to FIG. 5A, the sub-area 4A to 4C may confine measurement data elements such that each measurement data element is included only in one sub-area 4A to 4C.

With reference to FIG. 5B, a sub-area 6A to 6B may be selected by sliding a window indicated with a dotted line in the cellular the telecommunications network area. Each window position provides a sub-area 6A, 6B confining a group of measurement data elements. In such a case, a measurement data element may be included in more than one sub-area 6A to 6B.

In an embodiment of the invention, a spatiotemporal coordinate point is selected as a reference point, and measurement data elements with a given range from the reference point are deemed to belong to the sub-area 2A to 2E. Such a range may vary from dozens of meters to hundreds of meters, without restricting the range to the given figures.

The processing unit 334 calculates the sub-area cell quality parameters for selected sub-areas 2A to 2E and may store the sub-area cell quality parameters in the database unit 330 and/or in the memory unit 336. When the sub-area cell quality parameters are available, the processing unit 334 generates a cell preference list for at least a portion of the cellular telecommunications network area on the basis of the sub-area cell quality parameters. A cell preference list includes typically radio cell identifiers ordered according to the magnitudes of the cell quality parameters. For example, a first element of the cell preference list may indicate a radio cell 104A to 104F that provides the best signal quality for the mobile terminal 108. The next element of the cell preference list may indicate a radio cell 104A to 104F that provides the second best signal quality for the mobile terminal 108, etc.

In an embodiment of the invention, cell preference list information is delivered to the user interface 340 and the cell preference list is displayed graphically and/or numerically to the user of the analysing unit 304. The user may investigate the cell preference list and define for example, serving cell and neighbour cells for a given portion of the cellular telecommunications network area.

In an embodiment of the invention, a plurality of sub-area cell quality parameters are combined to generating the cell preference list. In such a case, sub-areas with a similar order of cell quality parameters are combined and a combined cell preference list is generated for those sub-areas 2A to 2B.

In an embodiment of the invention, the processing unit 334 generates sub-area-specific cell preference lists for the selected sub-areas on the basis of the sub-area cell quality parameters. A sub-area-specific preference list is generated from the sub-area quality parameters calculated for said sub-area 2A to 2E. The processing unit 334 may order the radio cell identifiers for radio cells 104A to 104F according to an ascending order of the sub-area cell quality parameters.

Information on the sub-area-specific cell preference list may be delivered to the user interface 340 and displayed to the user numerically and/or graphically.

In an embodiment of the invention, the processing unit 334 generates the cell preference list for the at least a portion of the cellular telecommunications network area by using the sub-area-specific cell preference lists. The processing unit 334 may compare the sub-area-specific cell preference lists and form a cellular telecommunications network area from sub-areas 2A to 2E having similar sub-area-specific cell preference lists.

In an embodiment of the invention, the processing unit 334 associates each sub-area 2A to 2E with a serving cell on the basis of the sub-area cell quality parameters. A radio cell 104A to 104F with the largest cell quality parameter may be selected as the serving cell.

Furthermore, the processing unit 334 may generate a sub-area-specific neighbour cell list for each sub-area 2A to 2E on the basis of the sub-area cell quality parameters. The sub-area-specific neighbour cell list may include cell identifiers of radio cells 104A to 104F having cell quality parameters above a predetermined neighbour cell threshold value. The user may define the predetermined neighbour cell threshold value may be fixed by using the user interface 340. The neighbour cell threshold value may be defined in a relative scale or in an absolute scale.

The processing unit 334 may further generate an overall neighbour cell list for at least one serving cell by combining sub-area-specific neighbour cell lists generated for sub-areas 2A to 2E associated with the at least one serving cell.

With reference to FIG. 4, consider sub-areas 2A to 2E. According to a cell coverage pattern, it may be presumed that the sub-area-specific cell preference lists be the following:

Preference list for sub-area 2A: 104A, 104D, 104C

Preference list for sub-area 2B: 104A, 104D

Preference list for sub-area 2C: 104B, 104F, 104A

Preference list for sub-area 2D: 104A, 104E

Preference list for sub-area 2E: 104F, 104A

A radio cell 104A may be selected as the serving cell for sub-areas 2A, 2B and 2D. As a result, the overall neighbour cell list for the serving cell in this case includes cell identifiers for radio cells 104D, 104C, 104E on the basis of the sub-area-specific cell preference lists given above.

In an embodiment of the invention, the processing unit 334 generates a sub-area-specific interfering cell list for each sub-area 2A to 2E on the basis of the sub-area cell quality parameters. A radio cell 104A to 104E may be selected as an interfering radio cell if the cell quality parameter of said cell ranges between predetermined interfering cell threshold values. The user may define the predetermined interfering cell threshold values by using the user interface 340. The interfering cell threshold values may be defined in a relative scale or in an absolute scale.

The processing unit 334 may further generate an overall interfering cell list for at least one serving cell by combining sub-area-specific interfering cell lists generated for sub-areas 2A to 2E associated with the at least one serving cell. The overall interfering cell list may be generated in a way similar to that of generating the overall neighbour cell list.

The database included in the database unit 330 may be extended to include measurement data and cell preference lists from large cellular telecommunications network areas. The database may be updated, and the cell preference lists may be recalculated with updated measurement data. The size and shape of the sub-areas 2A to 2E may be changed from those used in the previous calculations.

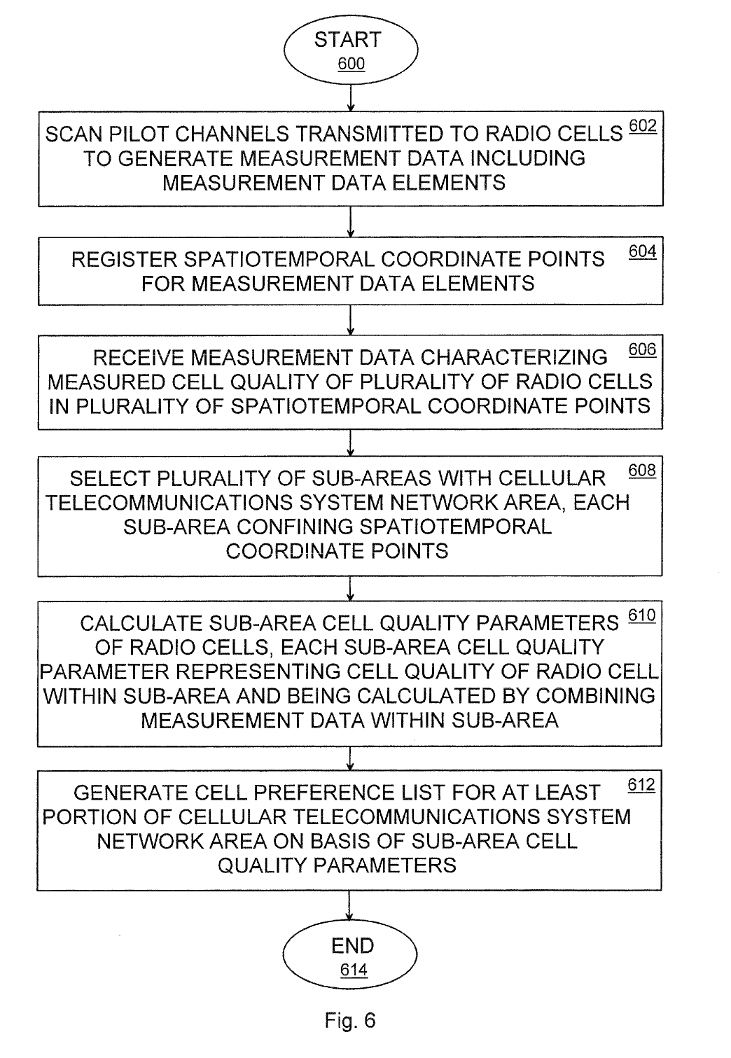

With reference to FIGS. 6, 7, and 8, methodology according to embodiments of the invention is illustrated.

With reference to FIG. 6, the method starts in 600.

In 602, pilot channels transmitted to radio cells 104A to 104E are scanned to generate measurement data including measurement data elements.

In 604, spatiotemporal coordinate points are registered for the measurement data elements.

In 606, measurement data characterizing measured cell quality of a plurality of radio cells 104A to 104E are received in a plurality of spatiotemporal coordinate points. In an embodiment of the invention, at least one spatiotemporal coordinate point is obtained from a satellite positioning system.

In an embodiment of the invention, the measurement data includes channel quality estimates being measured in a plurality of spatiotemporal coordinate points, the channel quality estimates measured from pilot channels transmitted to the radio cells 104A to 104F.

In 608, a plurality of sub-areas 2A to 2E is selected within a cellular telecommunications network area 100, each sub-area 2A to 2E confining a plurality of spatiotemporal coordinate points.

In 610, sub-area cell quality parameters of radio cells 104A to 104F are calculated, each sub-area cell quality parameter representing cell quality of a radio cell within a sub-area 2A to 2E and being calculated by combining measurement data within the sub-area 2A to 2E.

In 612, a cell preference list is generated for at least a portion of the cellular telecommunications network area 100 on the basis of the sub-area cell quality parameters.

In 614, the method ends.

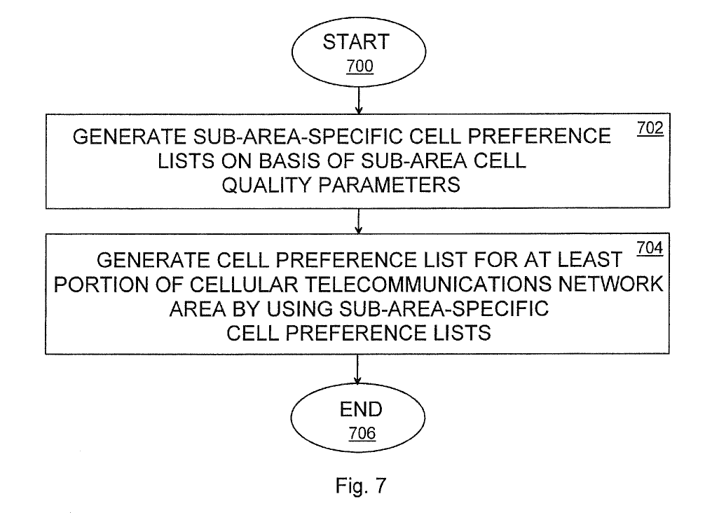

With reference to FIG. 7, the method starts in 700.

In 702, sub-area-specific cell preference lists are generated on the basis of sub-area cell quality parameters.

In 704, a cell preference list for the at least a portion of the cellular telecommunications network area is generated by using the sub-area-specific cell preference lists.

In 706, the method ends.

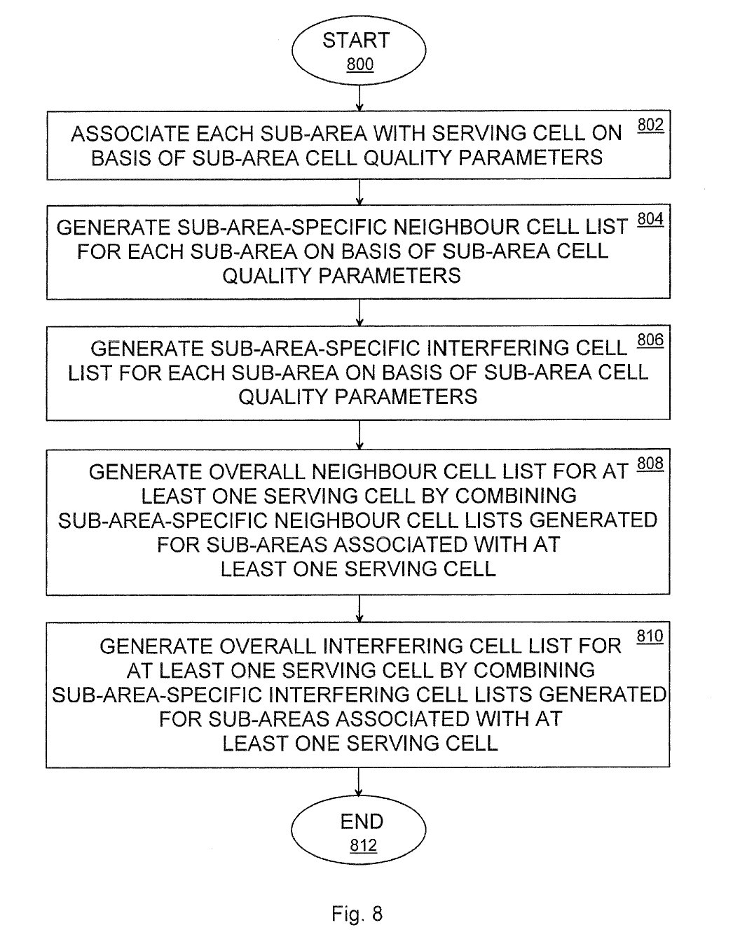

With reference to FIG. 8, the method starts in 800.

In 802, each sub-area 2A to 2E is associated with a serving cell on the basis of sub-area cell quality parameters.

In 804, a sub-area-specific neighbour cell list is generated for each sub-area 2A to 2E on the basis of the sub-area cell quality parameters.

In 806, a sub-area-specific interfering cell list is generated for each sub-area 2A to 2E on the basis of the sub-area cell quality parameters.

In 808, an overall neighbour cell list is generated for at least one serving cell by combining sub-area-specific neighbour cell lists generated for sub-areas 2A to 2E associated with the at least one serving cell.

In 810, an overall interfering cell list is generated for at least one serving cell by combining sub-area-specific interfering cell lists generated for sub-areas 2A to 2E associated with the at least one serving cell.

In 812, the method ends.

In an aspect, the invention provides a computer program product embodied on a computer readable distribution medium, such as a computer readable medium, a program storage medium, a record medium, a computer readable memory, a computer readable software distribution package, a computer readable signal, a computer readable telecommunications signal, and a computer readable compressed software package.

The computer program product encodes a computer program of instructions for executing a computer process including instruction for executing a computer process whose embodiments are shown in FIGS. 6, 7 and 8.

The computer program may be stored in the memory unit 336 of the analyzing unit 304 and executed in the processing unit.

Even though the invention has been described above with reference to an example according to the accompanying drawings, it is clear that the invention is not restricted thereto but it can be modified in several ways within the scope of the appended claims.

1. A method of characterizing a cellular telecommunications network area, the method comprising:
receiving measurement data characterizing measured cell quality of a plurality of radio cells in a plurality of spatiotemporal coordinate points;
selecting a plurality of sub-areas within a cellular telecommunications network area, each sub-area confining a plurality of spatiotemporal coordinate points;
calculating sub-area cell quality parameters of radio cells, each sub-area cell quality parameter representing cell quality of a radio cell within a sub-area and being calculated by combining measurement data within the sub-area; and
generating a cell preference list for at least a portion of the cellular telecommunications network area on the basis of the sub-area cell quality parameters.

2. The method of claim 1, further comprising:
generating sub-area-specific cell preference lists on the basis of the sub-area cell quality parameters; and
generating the cell preference list for the at least a portion of the cellular telecommunications network area by using the sub-area-specific cell preference lists.

3. The method of claim 1, further comprising:
associating each sub-area with a serving cell on the basis of the sub-area cell quality parameters;
generating sub-area-specific neighbour cell list for each sub-area on the basis of the sub-area cell quality parameters; and
generating an overall neighbour cell list for at least one serving cell by combining sub-area-specific neighbour cell lists generated for sub-areas associated with the at least one serving cell.

4. The method of claim 1, further comprising:
associating each sub-area with a serving cell on the basis of the sub-area cell quality parameters;
generating a sub-area-specific interfering cell list for each sub-area on the basis of the sub-area cell quality parameters; and
generating an overall interfering cell list for at least one serving cell by combining sub-area-specific interfering cell lists generated for sub-areas associated with the at least one serving cell.

5. The method of claim 1, further comprising:
scanning pilot channels transmitted to the radio cells to generate measurement data including measurement data elements; and
registering (spatiotemporal coordinate points for the measurement data elements.

6. The method of claim 1, further comprising:
receiving measurement data characterizing measured cell quality of a plurality of radio cells in a plurality of spatiotemporal coordinate points at least one of which being obtained from a satellite positioning system.

7. The method of claim 1, further comprising:
receiving measurement data including channel quality estimates measured in a plurality of spatiotemporal coordinate points, the channel quality estimates measured from pilot channels transmitted to the radio cells; and
calculating the sub-area cell quality parameters of radio cells by taking an average of the channel quality estimates of each cell within each sub-area.

8. A system for characterizing a cellular telecommunications network area, the system comprising:
a receiving means for receiving measurement data characterizing measured cell quality of a plurality of radio cells in a plurality of spatiotemporal coordinate points;
a selecting means for selecting a plurality of sub-areas within a cellular telecommunications network area, each sub-area confining a plurality of spatiotemporal coordinate points;
a calculating means for calculating sub-area cell quality parameters of radio cells, each sub-area cell quality parameter representing cell quality of a radio cell within a sub-area and being calculated by combining measurement data within the sub-area; and
a preference list generating means for generating a cell preference list for at least a portion of the cellular telecommunications network area on the basis of the sub-area cell quality parameters.

9. The system of claim 8, wherein the system further comprises a sub-area preference list generating means for generating sub-area-specific cell preference lists on the basis of the sub-area cell quality parameters; and the preference list generating means configured to generate the cell preference list for the at least a portion of the cellular telecommunications network area by using the sub-area-specific cell preference lists.

10. The system of claim 8, further comprising:
a first associating means for associating each sub-area with a serving cell on the basis of the sub-area cell quality parameters;
a sub-area-specific generating means for generating a sub-area-specific neighbour cell list for each sub-area on the basis of the sub-area cell quality parameters; and
the preference list generating means is configured to generate an overall neighbour cell list for at least one serving cell by combining sub-area-specific neighbour cell lists generated for sub-areas associated with the at least one serving cell.

11. The system of claim 8, further comprising:
a second associating means for associating each sub-area with a serving cell on the basis of the sub-area cell quality parameters;
an interfering cell list generating means for generating a sub-area-specific interfering cell list for each sub-area on the basis of the sub-area cell quality parameters; and
the preference list generating means is configured to generate an overall interfering cell list for at least one serving radio cell by combining sub-area-specific interfering cell lists generated for sub-areas associated with the at least one serving cell.

12. The system of claim 8, further comprising:
a scanning means for scanning pilot channels transmitted to the radio cells to generate measurement data including measurement data elements; and
a coordinate registering means for registering spatiotemporal coordinate points for the measurement data elements.

13. The system of claim 8, wherein the receiving means is configured to receive measurement data characterizing measured cell quality of a plurality of radio cells in a plurality of spatiotemporal coordinate points, at least one of which being obtained from a satellite positioning system.

14. The system of claim 8, wherein the receiving means is configured to receive measurement data including channel quality estimates measured in a plurality of spatiotemporal coordinate points, the channel quality estimates being measured from pilot channels transmitted to the radio cells; and
the calculating means is configured to calculate the sub-area cell quality parameters of radio cells by taking an average of the channel quality estimates of each cell within each sub-area.

15. A computer program product embodied on a computer readable distribution medium, the computer program product encoding a computer program of instructions for executing a computer process for characterizing a cellular telecommunications network area, the process comprising:
receiving measurement data characterizing measured cell quality of a plurality of radio cells in a plurality of spatiotemporal coordinate points;
selecting a plurality of sub-areas within a cellular telecommunications network area, each sub-area confining a plurality of spatiotemporal coordinate points;
calculating sub-area cell quality parameters of radio cells, each sub-area cell quality parameter representing cell quality of a radio cell within a sub-area and being calculated by combining measurement data within the sub-area; and
generating a cell preference list for at least a portion of the cellular telecommunications network area on the basis of the sub-area cell quality parameters.

16. A computer program distribution medium of claim 15, the distribution medium comprising a computer readable medium, a program storage medium, a record medium, a computer readable memory, a computer readable software distribution package, a computer readable signal, a computer readable telecommunications signal, and a computer readable compressed software package.
